(19) United States
(12) Patent Application Publication
(10) Pub. No.: US 2019/0035414 A1
(43) Pub. Date: Jan. 31, 2019

(54) ADAPTIVE POST FILTERING

(71) Applicant: HARMAN BECKER AUTOMOTIVE SYSTEMS GMBH, Karlsbad-Ittersbach (DE)

(72) Inventor: Markus CHRISTOPH, Straubing (DE)

(21) Appl. No.: 16/045,672

(22) Filed: Jul. 25, 2018

(30) Foreign Application Priority Data
Jul. 27, 2017 (EP) 17 183 510.1

(51) Int. Cl. G10L 19/26; G10L 21/0224; G10L 21/0232; H04R 3/00

(52) U.S. Cl. CPC G10L 19/26; G10L 21/0224; G10L 2021/02166; H04R 3/005; G10L 21/0232

(57) ABSTRACT

One embodiment is directed towards an adaptive post filtering system for noise reduction that includes a controllable filter block that is configured to generate, from a filter input signal, a filter output signal according to a filter transfer function, the filter transfer function being controllable with a filter control signal. The adaptive post filtering system further includes a statistical filter control block that is operatively coupled to the controllable filter block and configured to generate, according to a statistical optimization scheme, the filter control signal based on the input signal and a signal representative of noise contained in the filter input signal.

### CROSS-REFERENCE TO RELATED APPLICATIONS

This application claims priority to the co-pending European patent application titled, “ADAPTIVE POST FILTERING,” filed on Jul. 27, 2017 and having Serial No. EP 17 183 510.1. The subject matter of this related application is hereby incorporated herein by reference

### BACKGROUND

### Technical Field

The disclosure relates to an adaptive post filtering system and method and computer-readable storage medium that includes instructions for carrying out the method (also referred to herein as a “system”).

### Description of the Related Art

Systems for far field sound capturing, also referred to as far field microphones or far field microphone systems, are adapted to record sounds from a desired sound source that is positioned at a greater distance (e.g., several meters) from the far field microphone. The greater the distance between sound source and the far field microphone, the lower the desired sound to noise ratio is. The term “noise” in the instant case includes sound that carries no information, ideas or emotions, e.g., no speech or music. If the noise is undesired, it is also referred to as noise. When speech or music is introduced into a noise-filled environment such as a vehicle, home or office interior, the noise present in the interior can have an undesired interfering effect on a desired speech communication or music presentation. Noise reduction is commonly the attenuation of undesired signals but may also include the amplification of desired signals. Desired signals may be speech signals, whereas undesired signals can be any sounds in the environment which interfere with the desired signals. There have been three main approaches used in connection with noise reduction: Directional beamforming, spectral subtraction, and pitch-based speech enhancement. Systems designed to receive spatially propagating signals often encounter the presence of interference signals. If the desired signal and interferers occupy the same temporal frequency band, then temporal filtering cannot be used to separate the desired signal from the interferer. It is desired to improve noise reduction systems and methods.

### SUMMARY

An adaptive post filtering system for noise reduction includes a controllable filter block configured to generate, from a filter input signal, a filter output signal according to a filter transfer function, the filter transfer function being controllable with a filter control signal. The system further includes a statistical filter control block operatively coupled to the controllable filter block and configured to generate, according to a statistical optimization scheme, the filter control signal based on the input signal and a signal representative of noise contained in the filter input signal.

An adaptive post filtering method for noise reduction includes generating, from a filter input signal, a filter output signal according to a filter transfer function, the filter transfer function being controllable with a filter control signal, and generating, according to a statistical optimization scheme, the filter control signal based on the input signal and a signal representative of noise contained in the filter input signal.

Other systems, methods, features and advantages will be, or will become, apparent to one with skill in the art upon examination of the following detailed description and appended figures. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. In the Figures, like referenced numerals designate corresponding parts throughout the different views.

FIG. 1 is a schematic diagram illustrating an exemplary far field microphone system.

FIG. 2 is a schematic diagram illustrating an exemplary acoustic echo canceller applicable in the far field microphone system shown in FIG. 1.

FIG. 3 is a schematic diagram illustrating an exemplary filter and sum beamformer.

FIG. 4 is a schematic diagram illustrating an exemplary beam steering block.

FIG. 5 is a schematic diagram illustrating a simplified structure of an adaptive exemplary adaptive interference canceler with adaptive post filter and without an adaptive blocking filter.

FIG. 6 is a schematic diagram illustrating an exemplary adaptive post filter.

The Figures describe concepts in the context of one or more structural components. The various components shown in the figures can be implemented in any manner including, for example, software or firmware program code executed on appropriate hardware, hardware and any combination thereof. In some examples, the various components may reflect the use of corresponding components in an actual implementation. Certain components may be broken down into plural sub-components and certain components can be implemented in an order that differs from that which is illustrated herein, including a parallel manner.

### DETAILED DESCRIPTION

It has been found that the desired signals and interfering signals often originate from different spatial locations. Therefore, beamforming techniques may be used to improve signal-to-noise ratio in audio applications. Common beamforming techniques include delay and sum techniques, adaptive finite impulse response (FIR) filtering techniques using algorithms such as the Griffiths-Jim algorithm, and techniques based on the modeling of the human binaural hearing system.

Beamformers can be classified as either data independent or statistically optimum, depending on how the weights are chosen. The weights in a data independent beamformer do not depend on the array data and are chosen to present a specified response for all signal/interference scenarios. Statistically optimum beamformers select the weights to optimize the beamformer response based on statistics of the data. The data statistics are often unknown and may change with time, so adaptive algorithms are used to obtain weights that converge to the statistically optimum solution. Computational considerations dictate the use of partially adaptive beamformers with arrays composed of large numbers of sensors. Many different approaches have been proposed for implementing optimum beamformers. In general, the statistically optimum beamformer places nulls in the directions of interfering sources in an attempt to maximize the signal to noise ratio at the beamformer output.

In many applications the desired signal may be of unknown strength and may not always be present. In such situations, the correct estimation of signal and noise covariance matrices in the maximum signal-to-noise ratio (SNR) is not possible. Lack of knowledge about the desired signal may impede utilization of the reference signal approach. These limitations may be overcome through the application of linear constraints to the weight vector. Use of linear constraints is a very general approach that permits extensive control over the adapted response of the beamformer. A universal linear constraint design approach does not exist and in many applications a combination of different types of constraint techniques may be effective. However, attempting to find either a single best way or a combination of different ways to design the linear constraint may limit the use of techniques that rely on linear constraint design for beamforming applications.

Generalized sidelobe canceller (GSC) technology presents an alternative formulation for addressing the drawbacks associated with the linear constraint design technique for beamforming applications. Essentially, GSC is a mechanism for changing a constrained minimization problem into unconstrained form. GSC leaves the desired signals from a certain direction undistorted, while, at the same time, undesired signals radiating from other directions are suppressed. However, GSC uses a two path structure; a desired signal path to realize a fix beamformer pointing to the direction of the desired signal, and an undesired signal path that adaptively generates an ideally pure noise estimate, which is subtracted from the output signal of the fix beamformer, thus increasing its signal-to-noise ratio (SNR) by suppressing noise.

The undesired signal path, i.e. the estimation of the noise, may be realized in a two-part approach. A first block of the undesired signal path is configured to remove or block remaining components of the desired signal from the input signals of this block, which is, e.g., an adaptive blocking filter in case of a single input, or an adaptive blocking matrix if more than one input signal is used. A second block of the undesired signal path may further comprise an adaptive (multi-channel) interference canceller (AIC) in order to generate a single-channel, estimated noise signal, which is then subtracted from the output signal of the desired signal path, e.g., an optionally time delayed output signal of the fix beamformer. Thus, the noise contained in the optionally time delayed output signal of the fix beamformer can be suppressed, leading to a better SNR, as the desired signal component ideally would not be affected by this processing. This holds true if and only if all desired signal components within the noise estimation could successfully be blocked, which is rarely the case in practice, and thus represents one of the major drawbacks related to current adaptive beamforming algorithms.

Acoustic echo cancellation can be achieved, e.g., by subtracting an estimated echo signal from the total sound signal. To provide an estimate of the actual echo signal, algorithms have been developed that operate in the time domain and that may employ adaptive digital filters that process time-discrete signals. Such adaptive digital filters operate in such a way that network parameters defining the transmission characteristics of the filter are optimized with reference to a preset quality function. Such a quality function is realized, for example, by minimizing the average square errors of the output signal of the adaptive network with reference to a reference signal.

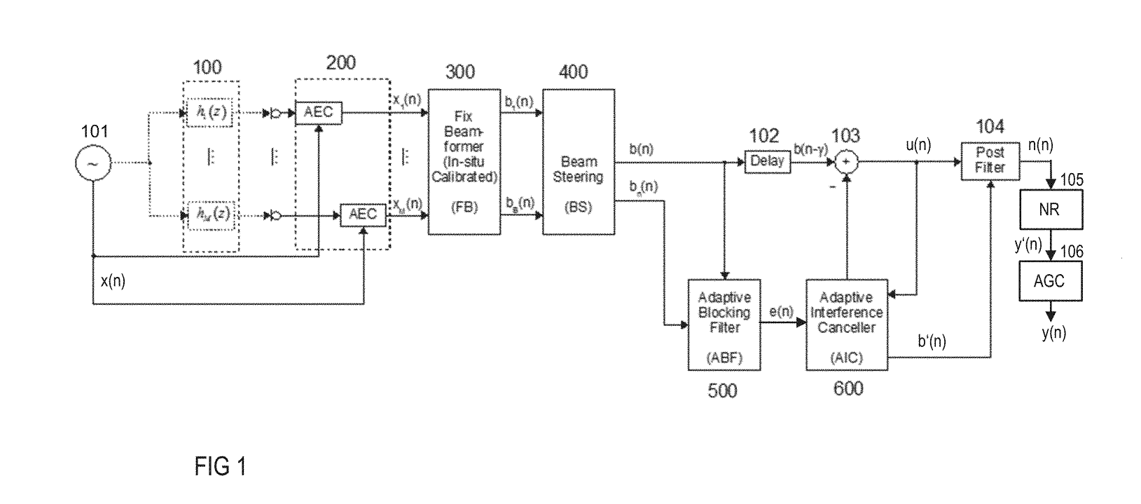

Referring now to FIG. 1, in an exemplary far field sound capturing system, sound, which corresponds to a source signal x(n) with n being a (discrete) time index, from a desired sound source 101, is radiated via one or a plurality of loudspeakers (not shown), travels through a room (not shown), where it is filtered with the corresponding room impulse responses (RIRs) 100 represented by transfer functions h₁(z) . . . h_{M}(z), wherein z being a frequency index, and may eventually be corrupted by noise, before the resulting sound signals are picked up by M (M is an integer, e.g., 2, 3 or more) microphones which provide M microphone signals. The exemplary far field sound capturing system shown in FIG. 1 includes an acoustic echo cancellation (AEC) block 200 providing M echo canceled signals x₁(n) . . . x_{M}(n), a subsequent fix beamformer (FB) block 300 providing B (B is an integer, e.g., 1, 2 or more) beamformed signals b₁(n) . . . b_{B}(n), a subsequent beam steering block 400 which provides a desired-source beam signal b(n), also referred to herein as positive-beam output signal b(n), and, optionally, an undesired-source beamsignal bₙ(n), also referred to herein as negative-beam output signal bₙ(n). The blocks 100, 200, 300 and 400 are operatively coupled with each other to form at least one signal chain (signal path) between block 100 and block 400. An optional undesired signal (negative-beam) operatively coupled with the output of beam steering block 400 and supplied with the undesired-source beam signal bₙ(n) includes an optional adaptive blocking filter (ABF) block 500 and a subsequent adaptive interference canceller (AIC) block 600 operatively coupled with the ABF block 500. The ABF block 500 may provide an error signal e(n). Alternatively, the original M microphone signals or the M output signals of the AEC block 200 or the B output signals of the FB block 300 may be used as input signals to the ABF block 500, optionally overlaid with the undesired-source beam signal bₙ(n), to establish an optional multichannel adaptive blocking matrix (ABM) block as well as an optional multichannel AIC block.

A desired signal (positive-beam) path also operatively coupled with the beam steering block 400 and supplied with the desired-source beam signal b(n) includes a series-connection of an optional delay block 102, a subtractor block 103 and an (adaptive) post filter block 104. The adaptive post filter 104 receives an output signal u(n) from the subtractor block 103 and a control signal b′(n) from AIC block 600. An optional speech pause detector (not shown) may be connected to and downstream of the adaptive post filter block 104 as well as a noise reduction (NR) block 105 and an optional automatic gain control (AGC) block 106, each of which, if present, may be connected upstream of the speech pause detector. It is noted that the AEC block 200, instead of being connected upstream of the FB block 300 as shown, may be connected downstream thereof, which may be beneficial if B<M, i.e., fewer beamformer blocks are available than microphones. Further, the AEC block 200 may be split into a multiplicity of sub-blocks (not shown), e.g., short-length sub-blocks for each microphone signal and a long-length sub-block (not shown) downstream of the BS block 400 for the desired-source beam signal and optionally another long-length sub-block (not shown) for the undesired-source beam signal. Further, the system is applicable not only in situations with only one source as shown but can be adapted for use in connection with a multiplicity of sources. For example, if stereo sources that provide two uncorrelated signals are employed, the AEC blocks may be substituted by stereo acoustic echo canceller (SAEC) blocks (not shown).

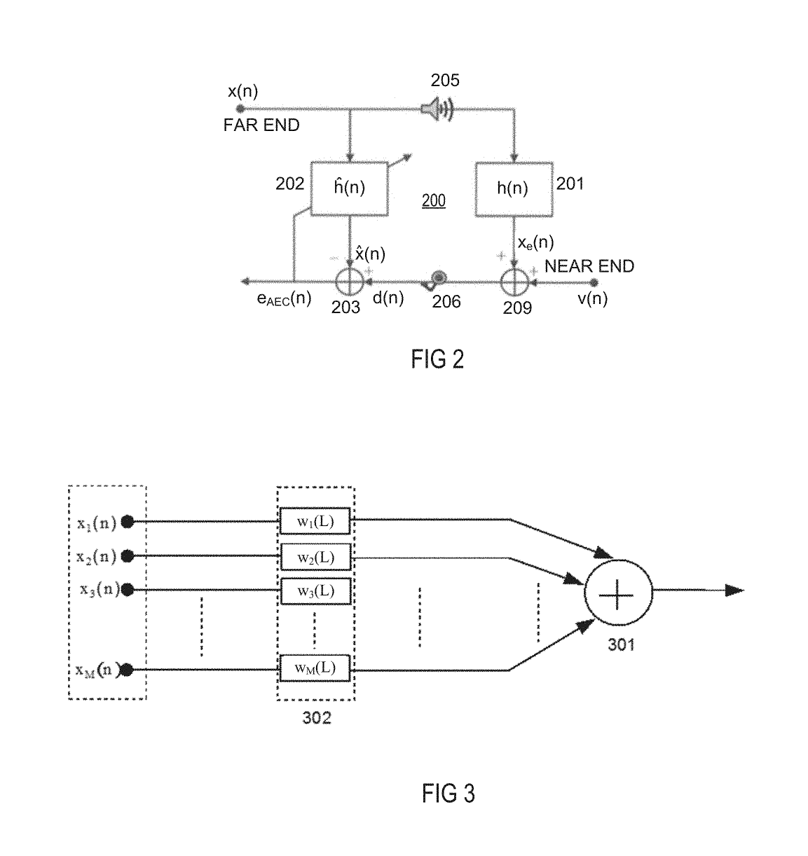

As can be seen from FIG. 1, N (=1) source signals x(n), filtered by the N×M RIRs, and possibly interfered with by noise, serve as an input to the AEC blocks 200. FIG. 2 depicts an exemplary realization of a single microphone (206), single loudspeaker (205) AEC block 200. As would be understood and appreciated by those skilled in the art, such a configuration can be extended to include more than one microphone 206 and/or more than one loudspeaker 205. A far end signal, represented by the source signal x(n), travels via loudspeaker 205 through an echo path 201 having the transfer function (vector) h(n)=(h₁, . . . , h_{M}) to provide an echo signal xₑ(n). This signal is added at a summing node 209 to a near-end signal v(n) which may contain both background noise and near-end speech, resulting in an electrical microphone (output) signal d(n). An estimated echo signal \hat{x}ₑ(n) provided by an adaptive filter block 202 is subtracted from the microphone signal d(n) at a subtracting node 203 to provide an error signal e_{AEC}(n). The adaptive filter 202 is configured to minimize the error signal e_{AEC}(n).

FIR filter 202 with transfer function ĥ(n) of order L−1, wherein L is a length of the FIR filter, is used to model the echo path. The transfer function ĥ(n) is given as

[ĥ(0,n), . . . ĥ(L−1,n),]^{T}

The desired microphone signal d(n) at block 203 for the adaptive filter is given as

d(n)=x^{T}(n)h(n)+v(n),

wherein x(n)=[x(n) x(n−1) . . . x(n−L+1)]^{T} is a real-valued vector containing L (L is an integer) most recent time samples of the input signal, x(n), and v(n), i.e., the near-end signal with may include noise.

Using the previous notations, the feedback/echo error signal is given as

e_{AEC}(n)=d(n)−x^{T}(n−1)ĥ(n)=x^{T}(n)[h(n)−ĥ(n)]+v(n),

wherein vectors h(n) and h(n) contain the filter coefficients representing the acoustical echo path and its estimation by the adaptive filter coefficients at time n. The cancellation filters ĥ(n) are estimated using, e.g., a Least Mean Square (LMS) algorithm or any state-of the art recursive algorithm. The LMS update using a step size of μ(n) of the LMS-type algorithm can be expressed as

ĥ(n)=ĥ(n−1)+μ(n)x(n)e(n).

A simple yet effective beamforming technique is the delay-and-sum (DS) technique. Referring again to FIG. 1, the outputs of AEC blocks 200 serve as inputs x₁(n), with i=1, . . . , M, to the fix beamformer block 300. A general structure of a fix filter and sum (FS) beamformer block 300 including filter blocks 302 with at least one of transfer functions wᵢ(L), i=1, . . . , M, and wᵢ(L)=[wᵢ(0), . . . , wᵢ(L−1)], L being the length of filters within the FB, is shown in FIG. 3. If the filter blocks 302 implement desired (factual) delays, the output beamformer signals bⱼ(n) with j=1, . . . , B, are given as

$${b}_{j} ( n ) = \frac{1}{M} {\sum }_{i = 1}^{M} {x}_{i} ( n - {τ}_{i , j} ) ,$$

wherein M is the number of microphones and for each (fix) beamformer output signal bⱼ(n) with j=1, . . . , B, each microphone has a delay τ_{i,j} relative to each other. The FS beamformer may include a summer 301 which receives the input signals xᵢ(n) via filter blocks 302 having the transfer functions wᵢ(L).

Referring again to FIG. 1, the beamformer signals bⱼ(n) output by the fix FS beamformer block 300 serve as an input to the beam steering (BS) block 400. Each signal from the fix beamformer block 300 is taken from a different room direction and may have a different SNR level. The input signals bⱼ(n) of the beam steering block 400 may contain low frequency components such as low frequency rumble, direct current (DC) offsets and unwanted vocal plosives in case of speech signals. These artifacts may impinge on the input signal bⱼ(n) of the BS block 400 and should be removed.

Alternatively, the beam pointing to the undesired signal (e.g., noise) source, i.e. the undesired-signal beam, can be approximated based on the beam pointing to the desired sound source, i.e. the desired-signal beam, by letting it point to the opposite direction of the beam pointing to the desired sound source, which would result in a system using less resources and also in beams having exactly the same time variations. Further, this allows both beams to never point in the same direction.

As a further alternative, instead of just using the beam pointing to the desired-source direction (positive beam) a summation of this with its neighboring beams may be used as positive-beam output signal, since all of them contain a high level of desired signals, which are correlated to each other and would as such be amplified by the summation. On the other hand, noise parts contained in the three neighboring beams are uncorrelated to each other and will as such be suppressed by the summation. As a result, the final output signal of the three neighboring beams will improve SNR.

The beam pointing to the undesired-source direction (negative beam) can alternatively be generated by using all output signals of the FB block except the one representing the positive beam. This leads to an effective directional response having a spatial zero in the direction of the desired signal source. Otherwise, an omnidirectional character is applicable, which may be beneficial since noise usually enters the microphone array also in an omnidirectional way, and only rarely in a directional form.

Further, the optionally delayed, desired signal from the BS block may form the basis for the output signal and as such is input into the optional adaptive post filter. The adaptive post filter, which is controlled by the AIC block and which delivers a filtered output signal, can optionally be input into a subsequent single channel noise reduction block (e.g., NR block 105 in FIG. 1), which may implement the known spectral subtraction method, and an optional (e.g., final) automatic gain control block (e.g., AGC block 106 in FIG. 1).

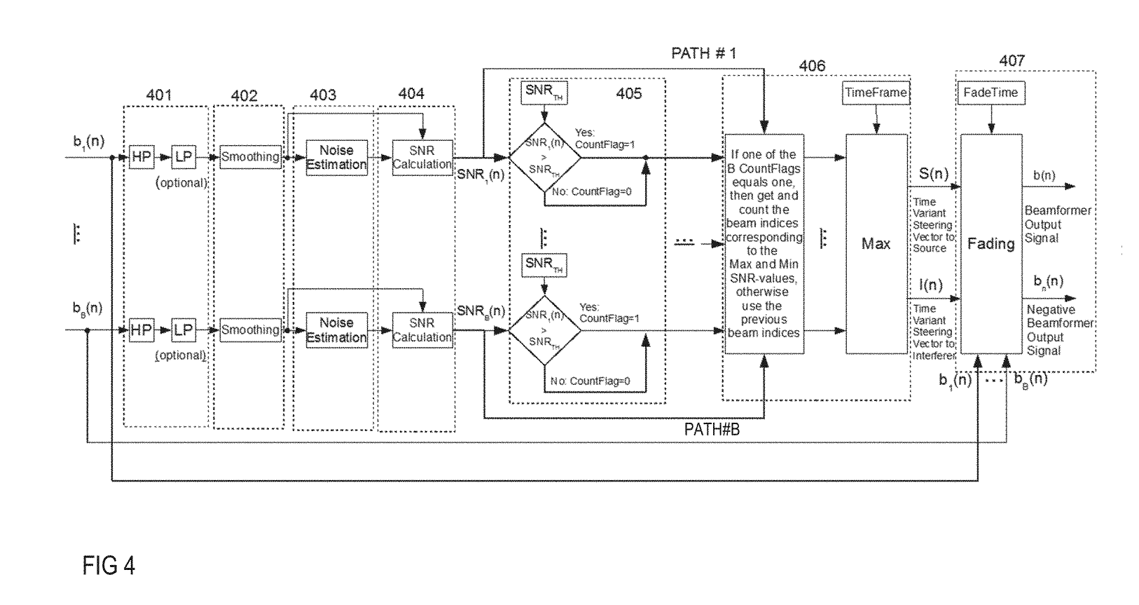

Referring to FIG. 4, in beam steering block 400 its input signals bⱼ(n) are filtered using a high pass (HP) filter and an optional low pass (LP) filter block 401 in order to block signal components that are either affected by noise or do not contain useful signal components, e.g., certain speech signal components. The output from filter block 401 may have amplitude variations due to noise that may introduce rapid, random changes in amplitude from point to point within the signal bⱼ(n). In this situation, it may be useful to reduce noise, e.g., in a smoothing block 402 shown in FIG. 4.

The filtered signal from filter block 401 is smoothed by applying, e.g., a low pass infinite impulse response (IIR) filter or an moving average (MA) finite impulse response (FIR) filter (both not shown) in smoothing block 402, thereby reducing the high frequency components and passing the low-frequency components with little change. The smoothing block 402 outputs a smoothed signal that may still contain some level of noise and thus, may cause noticeable sharp discontinuities as described above. The level of voice signals typically differs distinctly from the variation of the level of background noise, particularly due to the fact that the dynamic range of a level change of voice signals is greater and occurs in much shorter intervals than a level change of background noise. A linear smoothing filter in a noise estimation block 403 would therefore smear out the sharp variation in the desired signal, e.g., music or voice signal, as well as filter out the noise. Such smearing of a music or voice signal is unacceptable in many applications, therefore a non-linear smoothing filter (not shown) may be applied to the smoothed signal in noise estimation block 403 to overcome the artifacts mentioned above. The data points in output signal bⱼ(n) of smoothing block 402 are modified in a way that individual points that are higher than the immediately adjacent points (presumably because of noise) are reduced, and points that are lower than the adjacent points are increased. This leads to a smoother signal (and a slower step response to signal changes).

Next, based on the smoothed signal from smoothing block 402 and the estimated background noise signal from noise estimation block 403, the variations in the SNR value are calculated. Using variations in the SNR, a noise source can be differentiated from a desired speech or music signal. For example, a low SNR value may represent a variety of noise sources such as an air-conditioner, a fan, an open window, or an electrical device such as a computer etc. The SNR may be evaluated in a time domain or in a frequency domain or in a sub-band frequency domain.

In a comparator block 405, the output SNR value from block 404 is compared to a pre-determined threshold. If the current SNR value is greater than a pre-determined threshold, a flag indicating, e.g., a desired speech signal will be set to, e.g., ‘1’. Alternatively, if the current SNR value is less than a pre-determined threshold, a flag indicating an undesired signal such as noise from an air-conditioner, fan, an open window, or an electrical device such as a computer will be set to ‘0’.

SNR values from blocks 404 and 405 are passed to a controller block 406 via paths #1 to path #B. A controller block 406 compares the indices of a plurality of SNR (both low and high) values collected over time against the status flag in comparator block 405. A histogram of the maximum and minimum values is collected for a pre-determined time period. The minimum and maximum values in a histogram are representative of at least two different output signals. At least one signal is directed towards a desired source denoted by S(n) and at least one signal is directed towards an interference source denoted by I(n).

If the indices for low and high SNR values in controller block 406 change over time, a fading process is initiated that allows a smooth transition from one to the other output signal, without generating acoustic artifacts. The outputs of the BS block 400 represent desired-signal and optionally undesired-signal beams selected over time. Here, the desired-signal beam represents the fix beamformer output b(n) having the highest SNR. The optional undesired beam represents a fix beamformer output bₙ(n) having the lowest SNR.

The outputs of BS block 400 contain a signal with a high SNR (positive beam) which can be used as a reference by the optional adaptive blocking filter (ABF) block 500 and an optional one with a low SNR (negative beam), forming a second input signal for the optional ABF block 500. The ABF filter block 500 may use least mean square (LMS) algorithm controlled filters to adaptively subtract the signal of interest, represented by the reference signal b(n) (representing the desired-source beam) from the signal bₙ(n) (representing the undesired-source beam) and provides error signal(s) e(n). Error signal(s) e(n) obtained from ABF block 500 is/are passed to the adaptive interference canceller (AIC) block 600 which adaptively removes the signal components that are correlated to the error signals from the beamformer output of the fix beamformer 300 in the desired-signal path. As already mentioned, other signals can alternatively or additionally serve as input to the ABM block. However, the adaptive beamformer block including optional ABM, AIC and APF blocks can be partly or totally omitted.

First, AIC block 600 computes an interference signal using an adaptive filter (not shown). Then, the output of this adaptive filter is subtracted from the optionally delayed (with delay 102) reference signal b(n), e.g., by a subtractor 103 to eliminate the remaining interference and noise components in the reference signal b(n). Finally, an adaptive post filter 104 may be disposed downstream of subtractor 103 for the reduction of statistical noise components (not having a distinct autocorrelation). As in the ABF block 500, the filter coefficients in the AIC block 600 may be updated using the adaptive LMS algorithm. The norm of the filter coefficients in at least one of AIC block 600, ABF block 500 and AEC blocks may be constrained to prevent them from growing excessively large.

FIG. 5 illustrates an exemplary system for eliminating noise from the desired-source beam (positive beam) signal b(n). Thereby, the noise component included in the signal b(n), which is represented by signal z(n) in FIG. 5, is provided by an adaptive system, which includes a filter control block 700 that controls by way of a filter control signal b″(n) a controllable filter 800. The signal b(n) is subtracted by way of the subtractor block 103 from the desired signal b(n), optionally after being delayed in a delay block 102 as a delayed desired signal b(n−γ), to provide an adder output signal u(n) containing, to a certain extent, reduced undesired noise. The signal bₙ(n), which represents the undesired-signal beam and ideally only contains noise and no useful signal such as speech, is used as a reference signal for the filter control block 700 which also receives as an input the adder output signal. The known normalized least mean square (NLMS) algorithm may be used to filter noise out from the desired signal b(n) provided by BS block 400. The noise component in the desired signal b(n) is estimated by the adaptive system including filter control block 700 and controllable filter 800. Controllable filter 800 filters the undesired signal bₙ(n) under control of filter control block 700 to provide an estimate of the noise contained in the desired signal b(n), which is subtracted from the (optionally) delayed desired signal b(n−γ) in subtractor block 103 to reduce further noise in the desired signal b(n). This will in turn increase the signal-to-noise (SNR) ratio of the desired signal b(n). The filter control signal b″(n) from filter control block 700 is further used to control the adaptive post filter 104. The system shown in FIG. 5 employs no optional ABF or ABM block since an additional blocking of signal components of the undesired signal, performed by the ABF or ABM block, may be omitted if it has little effect in increasing the quality of the pure noise signal in comparison to the desired signal. Thus, it may be reasonable to omit the ABF or ABM block without deteriorating the performance of the adaptive beamformer dependent on the quality of the undesired signal bₙ(n).

Referring again to FIG. 1, the signal u(n) from subtractor 103 may be input to the APF block 104 which may output a signal n(n). The exemplary APF block 104 may operate based on a statistical approach and its purpose is to suppress in its input signal u(n) mainly statistical noise which could otherwise not be reduced by the adaptive beamforming structure upstream of the APF block 104, since this adaptive beamforming structure, e.g., including ABF 500 and/or AIC block 600, is limited to mainly suppress harmonic components of the noise, showing a distinct auto-correlation. The higher the share of statistical components in the background noise, which usually changes slowly over time, the more active an adaptive post filter (block) should be to achieve a higher noise suppression. On the other hand, if there is almost no background noise, a fix adjusted adaptive post filter (block) can degrade the speech quality, which is not desirable.

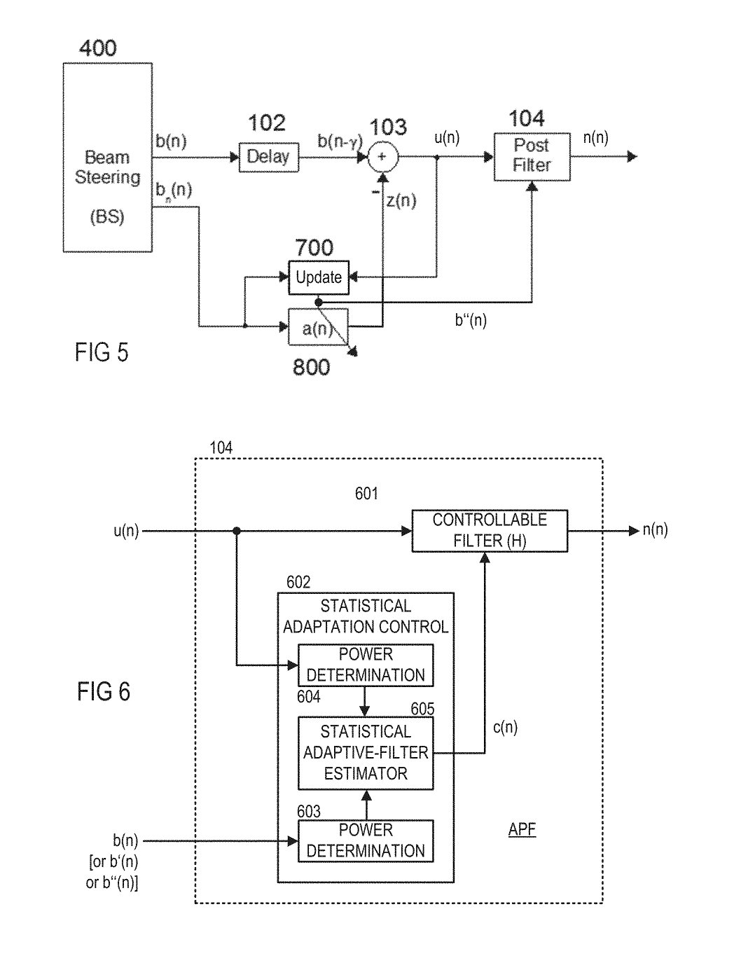

Referring to FIG. 6, an exemplary adaptive post filter applicable as adaptive post filter block 104 or in any other suitable application may include a controllable (transversal) filter block 601 which operates in a frequency selective fashion. The spectrum of the received signal u(n) is weighted as a function of frequency and time, depending on the instantaneous, spectral shape of the residual noise, the desired signal, and the background noise. The filter block 601 with a time-variant impulse response H is controlled/adjusted by a statistical filter control block 602 based on the signal u(n) and based on a signal that represents the background noise such as signal bₙ(n) from BS block 400 or a signal bₙ′(n) from adaptive system block 700 or a signal bₙ″(n) from AIC block 600. The statistical filter control block 602 includes a first power spectral density (PSD) evaluation block 603 which provides a first PSD signal that represents a power spectral density of the signal representing the background noise, e.g., signal bₙ″(n), a second power (spectral density) evaluation block 604 which provides a second PSD signal representing the power (spectral density) of the input signal u(n), and a statistical adaptive-filter estimation block 605 which responds to the first and to the second power (spectral density) signals, respectively, and determines and provides a filter control signal c(n).

The background noise (level) may be estimated (not shown) or may be available in any other way (shown), e.g., at the output of the beam steering unit 400, and used to control a minimum threshold Hₘᵢₙ(p_{bn}(n)) of the APF block 104, where p_{bn}(n) designates an estimated time-varying power of the estimated background noise signal bₙ(n), wherein

p_{bn}(n)=αp_{bn}(n−1)+(1−α)bₙ(n)²,

and α is a smoothing parameter (α∈[0, . . . , 1]).

The minimum threshold Hₘᵢₙ(p_{bn}(n)) of the APF block 104 forms the basis for a decision as to whether APF fblock 104 is active or not. Estimated background noise signal bₙ(n) is exemplarily taken as broadband signal which can be extracted from the beam steering unit 400, as shown in FIG. 4, where bₙ(n) could be generated as mean value of all B estimated background noise signals. Alternatively also a mean spectral version of the estimated background noise signal, stemming from a beam steering unit as shown in FIG. 5 can be used instead. Further, since the background noise estimates usually do not deviate very much over all B channels, it is possible to just use one representative for bₙ(n), either in the time or in the spectral domain. Another option would be to explicitly use the estimated background noise signal of the negative beam since this one should always contain the maximum of the background noise.

Thereby, the input power controlled, minimum threshold Hₘᵢₙ(p_{bn}(n)) may be realized as follows:

$${H}_{min} ( {p}_{bn} ( n ) ) = \{ \begin{matrix}{p}_{bndB} ( n ) - {p}_{bndBTH} + {H}_{MinInit} , if {p}_{bndB} > {p}_{bddBTH} \\ {H}_{MinInit} , else\end{matrix} ,$$

with H_{MinInit} is a fix minimum threshold, independent of the estimated background noise power, p_{bndB}(n)=10 log₁₀ {p_{bn}(n)} is the estimated background noise power in [dB], and p_{bn dBTH} is a threshold for the estimated background noise power in [dB].

This means, if the current estimated background noise power p_{bndB}(n) (in [dB]) remains below a certain estimated background noise power threshold p_{bndBTH}, a fix minimum threshold H_{MinInit} will be used for Hₘᵢₙ(p_{bn}((n)). Otherwise, the momentary threshold Hₘᵢₙ(p_{bn}(n)) will be calculated based on the momentary input power p_{bndB}(n), the minimum threshold H_{MinInit} and the estimated background noise power threshold p_{bndBTH} in such a way that it will linearly rise (in the logarithmic domain) together with the estimated background noise power.

The system and method described above may be implemented by way of a frequency-domain adaptive filter (FDAF) which offers a high convergence rate and moderate computational complexity. In such implementation, the FDAF may be considered as a normalized least-mean-square (LMS) type adaptive filter with one tap-weight in each frequency bin. With a given step size, the dynamic behavior of the FDAF can be described by a first order difference equation of the (residual) noise where a statistical model parameter is added. This statistical model parameter is the expectation of the magnitude-squared frequency response corresponding to the (residual) noise, i.e., the estimated (residual) noise. Optimization of the step size and normalization of the optimized (optimum) step size based on the APF input signal allows that a predicted convergence state solely depends on the result of a previous iteration, a time- and frequency dependent forgetting factor, and the statistical model parameter. If, for example, an FDAF is employed in the AIC block 600 shown in FIG. 1, this FDAC may be also used for the APF block 104 with minor changes and/or additions.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices. The described methods and associated actions may also be performed in various orders in addition to the order described in this application, in parallel, and/or simultaneously. The described systems are exemplary in nature, and may include additional elements and/or omit elements.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects.

The embodiments of the present disclosure generally provide for a plurality of circuits, electrical devices, and/or at least one controller. All references to the circuits, the at least one controller, and other electrical devices and the functionality provided by each, are not intended to be limited to encompassing only what is illustrated and described herein. While particular labels may be assigned to the various circuit(s), controller(s) and other electrical devices disclosed, such labels are not intended to limit the scope of operation for the various circuit(s), controller(s) and other electrical devices. Such circuit(s), controller(s) and other electrical devices may be combined with each other and/or separated in any manner based on the particular type of electrical implementation that is desired.

A block is understood to be a hardware system or an element thereof with at least one of: a processing unit executing software and a dedicated circuit structure for implementing a respective desired signal transferring or processing function. Thus, parts or all of the system may be implemented as software and firmware executed by a processor or a programmable digital circuit. It is recognized that any system as disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any system as disclosed may utilize any one or more microprocessors to execute a computer-program that is embodied in a non-transitory computer readable medium that is programmed to perform any number of the functions as disclosed. Further, any controller as provided herein includes a housing and a various number of microprocessors, integrated circuits, and memory devices, (e.g., FLASH, random access memory (RAM), read only memory (ROM), electrically programmable read only memory (EPROM), and/or electrically erasable programmable read only memory (EEPROM).

While various embodiments of the invention have been described, it will be apparent to those of ordinary skilled in the art that many more embodiments and implementations are possible within the scope of the invention. In particular, the skilled person will recognize the interchangeability of various features from different embodiments. Although these techniques and systems have been disclosed in the context of certain embodiments and examples, it will be understood that these techniques and systems may be extended beyond the specifically disclosed embodiments to other embodiments and/or uses and obvious modifications thereof.

What is claimed is:

1. An adaptive post filtering system for noise reduction, the system comprising:
a controllable filter block configured to generate, from a filter input signal, a filter output signal according to a filter transfer function, the filter transfer function being controllable with a filter control signal; and
a statistical filter control block operatively coupled to the controllable filter block and configured to generate, according to a statistical optimization scheme, the filter control signal based on the input signal and a signal representative of noise contained in the filter input signal.

2. The system of claim 1, wherein the statistical filter control block comprises:
a first power evaluation block configured to generate a signal representative of the power of the signal representative of the noise contained in the filter input signal;
a second power evaluation block configured to generate a signal representative of the power of the filter input signal; and
a statistical adaptive-filter estimator operatively coupled to the first power evaluation block and the second power evaluation block, and configured to generate the filter control signal based on the signal representative of the power of the signal representative of the noise contained in the filter input signal and the signal representative of the power of the filter input signal according to the statistical optimization scheme.

3. The system of claim 2, wherein the statistical adaptive-filter estimator is further configured to determine a step size, to optimize the step size and to normalize the optimized step size based on the filter input signal so that a predicted convergence state solely depends on a result of a previous iteration, a time- and frequency dependent forgetting factor, and a statistical model parameter.

4. The system of claim 3, wherein the statistical model parameter is based on an estimation of the noise contained in the filter input signal.

5. The system of claim 3, wherein the statistical model parameter is at least partly based on a signal from a beamformer, wherein the signal represents a beam that is directed to a noise source from which at least components of the noise contained in the filter input signal originate.

6. The system of claim 5, wherein the signal from the beamformer represents a beam that is directed to a noise source from which at least components of the noise contained in the filter input signal originate.

7. The system of any of claim 1, wherein the statistical adaptive-filter estimator is configured to adaptively control the filter transfer function if the noise estimate exceeds a predetermined noise threshold, and otherwise set the filter transfer function to a predetermined transfer function.

8. An adaptive post filtering method for noise reduction, the method comprising:
generating, from a filter input signal, a filter output signal according to a filter transfer function, the filter transfer function being controllable with a filter control signal; and
generating, according to a statistical optimization scheme, the filter control signal based on the input signal and a signal representative of noise contained in the filter input signal.

9. The method of claim 8, wherein generating the filter control signal based on the input signal and the signal representative of noise contained in the filter input signal comprises:
generating a signal representative of the power of the signal representative of the noise contained in the filter input signal;
generating a signal representative of the power of the filter input signal; and
generating the filter control signal based on the signal representative of the power of the signal representative of the noise contained in the filter input signal and the signal representative of the power of the filter input signal according to the statistical optimization scheme.

10. The method of claim 9, wherein generating the filter control signal based on the signal representative of the power of the signal representative of the noise contained in the filter input signal and the signal representative of the power of the filter input signal comprises: determining a step size, optimizing the step size and normalizing the optimized step size based on the filter input signal so that a predicted convergence state solely depends on a result of a previous iteration, a time- and frequency dependent forgetting factor, and a statistical model parameter.

11. The method of claim 10, wherein the statistical model parameter is derived from an estimation of the noise contained in the filter input signal.

12. The method of claim 10, wherein the statistical model parameter is at least partly derived from a signal from a beamformer, wherein the signal represents a beam that is directed to a noise source from which at least components of the noise contained in the filter input signal originate.

13. The method of claim 12, wherein the signal from the beamformer represents a beam that is directed to a noise source from which at least components of the noise contained in the filter input signal originate.

14. The method of any of claim 8, wherein generating the filter control signal based on the signal representative of the power of the signal representative of the noise contained in the filter input signal and the signal representative of the power of the filter input signal comprises adaptively controlling the filter transfer function if the noise estimate exceeds a predetermined noise threshold, and otherwise setting the filter transfer function to a predetermined transfer function.

15. A non-transitory computer-readable medium including instructions that, when executed by a processor, cause the processor to perform the steps of:
generating, from a filter input signal, a filter output signal according to a filter transfer function, the filter transfer function being controllable with a filter control signal; and
generating, according to a statistical optimization scheme, the filter control signal based on the input signal and a signal representative of noise contained in the filter input signal.
